(19) United States
(12) Patent Application Publication
(10) Pub. No.: US 2007/0234065 A1
(43) Pub. Date: Oct. 4, 2007

(54) Biometric identification device providing format conversion functionality and method for implementing said functionality

(75) Inventors: Guy Dufour, Saint-Nicolas (CA); Stephane Gervais, Saint-Nicolas (CA)

Correspondence Address: FETHERSTONHAUGH - SMART & BIGGAR, 1000 DE LA GAUCHETIERE WEST, SUITE 3300, MONTREAL, QC, H3B 4W5, CA

(73) Assignee: LABCAL TECHNOLOGIES INC.

(21) Appl. No.: 11/396,707

(22) Filed: Apr. 4, 2006

(51) Int. Cl. H04K 1/00

(52) U.S. Cl. 713/186

(57) ABSTRACT

A biometric authentication device is provided comprising a first interface, a conversion database a second interface, a processing unit and an output. The first interface is for receiving a live biometric signal associated to a person. The conversion database has a plurality of entries associated to respective formats and including conversion instructions for converting information from each of the respective format into information into a common reference format. The second interface is for receiving information from a contactless chip including information conveying a certain format associated with the contactless chip. The processing unit is operative for deriving authentication information associated to the person. In the absence of an entry in the conversion database associated to the certain format, the processing unit is operative for establishing a communication link with an external entity for issuing a request to receive conversion instructions for converting information in the certain format to information in the common reference format. The processing unit receives a signal conveying conversion instructions for converting information in the certain format to information in the common reference format and updates the conversion database to include an entry associated to the certain format. The output is for releasing a signal conveying the authentication information.

### FIELD OF THE INVENTION

The present invention relates to the field of biometric authentication methods and devices, and more specifically, to methods and devices for processing biometric information associated to different individuals so as to provide authentication information associated to those individuals.

### BACKGROUND OF THE INVENTION

Security systems and authentication devices for screening people who are crossing borders, or entering restricted areas, are known in the art. More and more, such systems and devices are using biometric information in order to perform the authentication and screening processes. As opposed to other forms of authentication that can be easily stolen, such as pin numbers and traditional access cards, biometric information is not considered as being easily stolen and has proven to provide improved security and reliability when authenticating individuals.

In the specific context of travelling across borders, travelers are required to carry with them some sort of identification documentation, which has traditionally been a paper passport. In many countries, new passports and other types of identification documentation are now equipped with an electronic chip that is either embedded in a smart card or other paper documentation. Such electronic chips generally store a plurality of information elements associated to the traveler and often include biometric information.

In a typical interaction, border crossing personnel is equipped with screening devices capable of acquiring live biometric information from an individual and well as for reading information stored on an electronic chip which is part of the individual's identification documentation. Each screening device includes application software capable of processing the live biometric information against the information stored on the electronic chip to determine whether there is a match. The application software may also be adapted to perform some other security verification processes, such as for example, verifying whether the individual is on any restricted security lists.

As borders become blurred, such as for example in the European Union, an increasing number of travelers from a plurality of different countries will cross borders on a daily basis. Generally, a traveler's identification documentation will be issued by the country in which the traveler is a citizen. In light of the above, it is likely that each, country will have its own particular format and/or protocol for storing information within the chip or smart card. A deficiency with existing systems and devices for reading and processing the information stored in the electronic chip of a traveler's identification documentation is that they require application software which is able to process the different electronic chip formats. As the number of different formats increases, this results in complex systems and/or devices that are difficult to update and manage since any modification brought to the application software must be propagated to each of the different formats.

As the popularity of identification documentation equipped with electronic chips increases, new or updated formats and/or protocols will be introduced for storing information on smart cards or chips. As such, as protocols change or get updated to new protocols, the application software must also be modified accordingly, such that it can be applied to information in the new format or using the new protocols. As such, as new protocols or updates are introduced, the ability to process a plurality of different types of cards or chips becomes increasingly complex, as the application software will also need to be modified and updated. It should also be appreciated that an inability to process an electronic chips having a certain format or protocol will result in an undue wait and inconvenience for both the traveler and the border crossing official.

The above deficiencies associated with being able to read and process information stored in different formats and/or protocols is not limited to systems and devices used at border crossings. Such deficiencies may also exist in secure buildings that have restricted areas. In fact, any access control type of application relying on ID cards equipped with radio frequency identification tags is subject to the mentioned deficiencies.

Current systems provide no convenient manner for accommodating these different protocols or for allowing new protocols to be introduced in authentication devices.

In light of the above, it can be seen that there is a need in the industry for an improved method and system for authenticating individuals on the basis of information stored in an electronic chip which alleviates, at least in part, the deficiencies of existing systems.

### SUMMARY OF THE INVENTION

In accordance with a broad aspect, the present invention provides a biometric authentication device comprising a first interface, a second interface, a processing unit and an output. The first interface is for receiving a live biometric signal associated to a person. The second interface is for receiving information from a contactless chip. The information received at the second interface includes first information conveying a certain format associated with the contactless chip, the certain format being selected from a plurality of possible formats, and second information conveying biometric data, the second information being in the certain format. The processing unit is in communication with the first interface and the second interface and is operative for converting the second information to a common reference format at least in part on the basis of the first information. The processing unit is also adapted for deriving authentication information associated to the person at least in part on the basis of the second information in the common reference format. The output is for releasing a signal conveying the authentication information.

For the purpose of this specification, the expression “contactless chip” is used to broadly describe an entity including an electronic chip capable of storing data contained thereon and of transferring that data to another entity via a wireless connection. The wireless connection is typically a radio-frequency (RF) connection although other types of wireless connections may also be used. Such contactless chips may be included in devices such as smart cards, ID tags, travel documents and access cards to name a few.

In accordance with a specific implementation, the biometric authentication device is a portable unit. In yet another specific implementation, the biometric authentication device is a hand-held portable unit. It will however be appreciated that, in alternative embodiments, the biometric authentication device may be fixed in a console or other non-portable entity.

In a specific implementation, the second information conveys nominative information in addition to the biometric data. Such nominative information may include, without being limited to, a person's name, birthday, address, citizenship, passport number, driver's license and any other information that may be of interest depending on the specific application.

In accordance with a specific implementation, the biometric authentication device includes a conversion database including a plurality of entries, the entries being associated to respective formats and including conversion instructions for converting information in each of the respective formats into information in the common reference format. The processing is operative for retrieving from the conversion database an entry associated to the certain format, the entry including conversion instructions for converting information in the certain format into information in the common reference format.

In accordance with a specific implementation, the live biometric signal received at the first interface may convey any suitable biometric information associated to a person, including but not limited to: a fingerprint, retinal information, iris information, facial recognition information and voice recognition information. In a specific implementation where the live biometric signal conveys a fingerprint associated to the person, the biometric authentication includes a fingerprint scanner adapted for receiving thereon at least a portion of a person finger to obtain fingerprint information.

In accordance with another broad aspect, the present invention provides a biometric authentication device comprising a first interface, a conversion database, a second interface, a processing unit and an output. The first interface is for receiving a live biometric signal associated to a person. The conversion database has a plurality of entries, the entries being associated to respective formats and including conversion instructions for converting information from each of the respective format into information into a common reference format. The second interface is for receiving information from a contactless chip, the information conveying a certain format associated with the contactless chip. The certain format is selected from a plurality of possible formats including at least one format absent from the conversion database. The processing unit is in communication with the first interface, the second interface and the conversion database and is operative for deriving authentication information associated to the person. In the absence of an entry in the conversion database associated to the certain format, the processing unit is operative for establishing a communication link with an external entity for issuing a request to receive conversion instructions for converting information in the certain format to information in the common reference format. The processing unit is also adapted for receiving a signal conveying conversion instructions for converting information in the certain format to information in the common reference format and for updating the conversion database to include an entry associated to the certain format at least in part on the basis of the signal received. The output is for releasing a signal conveying the authentication information.

In accordance with a specific implementation, the information received at the second interface is first information and the second interface is adapted for receiving second information conveying biometric data in the certain format. The processing unit is operative for attempting to locate an entry in the conversion database corresponding to the certain format. When an entry corresponding to the certain format has been located in the conversion database, the processing unit is operative for converting the second information to the common reference format at least in part on the basis of the entry in the conversion database corresponding to the certain format. The processing unit is also adapted for deriving authentication information associated to the person at least in part on the basis of the second information in the common reference format.

In a specific implementation, the second information conveys nominative information in addition to the biometric data. Such nominative information may include for example, without being limited to, a person's name, birthday, address, citizenship, passport number, driver's license and any other information that may be of interest depending on the specific application.

In accordance with another broad aspect, the invention provides a method for providing authentication information associated to a person for use in a biometric authentication device of the type described above. The method comprises receiving information conveying a certain format associated with the contactless chip, the certain format being selected from a plurality of possible formats, the set of possible formats including at least one format absent from the conversion database. The method also includes attempting to locate an entry in the conversion database corresponding to the certain format. The method comprises, in the absence of an entry in the conversion database associated to the certain format:
a) establishing a communication link with an external entity for issuing a request to receive conversion instructions for converting information in the certain format to information in the common reference format;
b) receiving a signal conveying conversion instructions for converting information in the certain format to information in the common reference format;
c) updating the conversion database to include an entry associated to the certain format at least in part on the basis of the signal received.

In accordance with a specific example of implementation, the method comprises receiving information conveying biometric data, the second information being in the certain format. When an entry corresponding to the certain format has been located in the conversion database, the method comprises converting the second information conveying biometric data to the common reference format at least in part on the basis of the entry in the conversion database corresponding to the certain format. The method also includes deriving authentication information associated to the person at least in part on the basis of the information in the common reference format conveying biometric data.

In accordance with another broad aspect, the invention provides computer readable storage medium including a program element suitable for execution by a computing apparatus for providing authentication information associated to a person in accordance with the above-described method.

In accordance with another broad aspect, the invention provides a biometric authentication device comprising means for receiving a live biometric signal associated to a person. The biometric authentication device also comprises conversion database means having a plurality of entries, the entries being associated to respective formats and including conversion instructions for converting information from each of the respective format into information into a common reference format. The biometric authentication device also comprises means for receiving information from a contactless chip, the information conveying a certain format associated with the contactless chip. The certain format is selected from a plurality of possible formats, the set of possible formats including at least one format absent from the conversion database. The biometric authentication device also comprises means for deriving authentication information associated to the person. On the absence of an entry in the conversion database means associated to the certain format, the means for deriving authentication information are operative for:
i. establishing a communication link with an external entity for issuing a request to receive conversion instructions for converting information in the certain format to information in the common reference format;
ii. receiving a signal conveying conversion instructions for converting information in the certain format to information in the common reference format; and
iii. updating the conversion database means to include an entry associated to the certain format at least in part on the basis of the signal received.
   The biometric authentication device also includes means for releasing a signal conveying the authentication information.

In accordance with yet another broad aspect, the invention provides a computing entity suitable for communicating with one or more remote biometric authentication devices. The computing entity includes a communication port, a master conversion database and a processing unit. The communication port is suitable for exchanging signals with one or more biometric authentication devices. The master conversion database includes a plurality of entries, the entries in the master conversion database being associated to respective formats and including conversion instructions for converting information in each of the respective formats into information in a common reference format. The processing unit is in communication with the master conversion database and with the communication port. The processing unit is operative for receiving a signal originating from a certain biometric authentication device and conveying a request for conversion instructions for converting information in a certain format to information in the common reference format. The processing unit is also operative for locating in the master conversion database an entry corresponding to the certain format and for causing a signal to be released at the communication port for transmission to the certain biometric authentication device. The signal caused to be released at the communication port conveys conversion instructions for converting information in the certain into information in the common reference format.

In accordance with yet another broad aspect, the invention provides a biometric authentication device comprising a first interface, a second interface, a third interface, a conversion database and a processing unit. The first interface is for receiving a live biometric signal associated to a person, the second interface for receiving information from a contactless chip and the third interface is for communicating with an external computing entity. The conversion database has a plurality of entries associated to respective formats and including conversion instructions for converting information from each of the respective format into information into a common reference format. The processing unit is in communication with the first interface, the second interface, the third interface and the conversion database. The processing unit is operative for receiving information associated to a certain format from the external computing entity and for attempting to locate an entry in the conversion database corresponding to the certain format. In the absence of an entry in the conversion database associated to the certain format, the processing unit is operative for establishing a communication link with the external computing entity for receiving conversion instructions for converting information from the certain format to the common reference format and for updating the conversion database to include an entry associated to the certain format.

In accordance with another broad aspect, the invention provides a method for updating the conversion database a conversion database for use in a biometric authentication device of the type described above. The method comprises receiving information associated to a certain format from an external computing entity and attempting to locate an entry in the conversion database corresponding to the certain format. In the absence of an entry in the conversion database associated to the certain format, the method comprises establishing a communication link with the external computing entity for receiving conversion instructions for converting information from the certain format to the common reference format and updating the conversion database to include an entry associated to the certain format.

In accordance with another broad aspect, the invention provides computer readable storage medium including a program element suitable for execution by a computing apparatus for providing authentication information associated to a person in accordance with the above-described method.

In accordance with another broad aspect, the invention provides a computing entity suitable for communicating with one or more remote biometric authentication devices. The computing entity comprises a communication port suitable for exchanging signals with one or more biometric authentication devices, a master conversion database and a processing unit. The master conversion database includes a plurality of entries associated to respective formats in a set of possible formats. The entries include conversion instructions for converting information in each of the respective formats into information in a common reference format. The processing unit is in communication with the master conversion database and with the communication port. The processing unit being operative for releasing a first signal at the communication port for transmission to one or more biometric authentication devices. The first signal conveys a certain format from the set of possible format for which conversion instructions for converting information from the certain format into information in the common reference format are available in the master conversion database. In response to an incoming signal originating from a certain biometric authentication device conveying a request for conversion instructions for converting information in the certain format to information in the common reference format, the processing unit releases at the communication port a second signal for transmission to the certain biometric authentication device. The second signal conveys conversion instructions for converting information in the certain into information in the common reference format.

In accordance with another broad aspect, the invention provides a biometric authentication device comprising means for receiving a live biometric signal associated to a person, means for receiving information from a contactless chip and means for communicating with an external computing entity. The biometric authentication device also comprises a conversion database having a plurality of entries, the entries being associated to respective formats and including conversion instructions for converting information from each of the respective format into information into a common reference format. The biometric authentication device also comprises processing means operative for receiving information associated to a certain format from the external computing entity and attempting to locate an entry in the conversion database corresponding to the certain format. In the absence of an entry in the conversion database associated to the certain format, the processing means is operative for establishing a communication link with the external computing entity for receiving conversion instructions for converting information from the certain format to the common reference format and for updating the conversion database to include an entry associated to the certain format.

These and other aspects and features of the present invention will now become apparent to those of ordinary skill in the art upon review of the following description of specific embodiments of the invention and the accompanying drawings.

### BRIEF DESCRIPTION OF THE DRAWINGS

In the accompanying drawings:

FIG. 1 shows a biometric authentication device in accordance with a non-limiting example of implementation of the present invention, shown in proximity to a smart card;

FIG. 2 shows a functional block diagram of the biometric authentication device shown in FIG. 1;

FIG. 3 shows a flow diagram of a method for generating authentication information in accordance with a non-limiting example of implementation of the present invention;

FIG. 4 shows a representation of a database used by the biometric authentication device shown in FIG. 1;

FIG. 5 shows a non-limiting example of a computing entity in communication with a plurality of biometric authentication devices;

FIG. 6 shows a functional block diagram of a computing entity in accordance with a non-limiting example of implementation of the present invention; and

FIG. 7 shows a flow diagram of a method for updating a conversion database in accordance with a non-limiting example of implementation of the present invention.

Other aspects and features of the present invention will become apparent to those ordinarily skilled in the art upon review of the following description of specific embodiments of the invention in conjunction with the accompanying figures.

### DETAILED DESCRIPTION

The Biometric Authentication Device

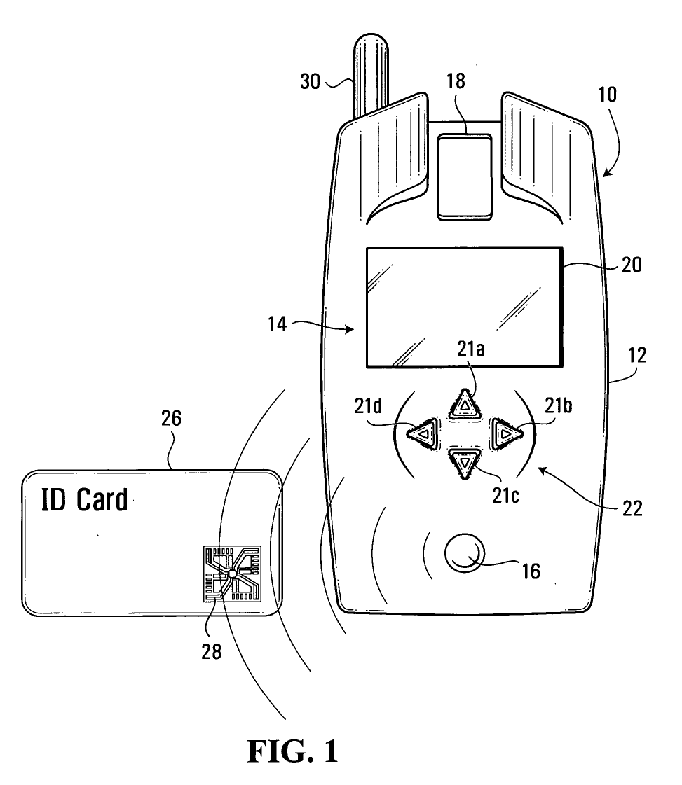

Shown in FIG. 1 is a biometric authentication device 10 in accordance with a non-limiting example of implementation of the present invention. Although the biometric authentication device 10 shown in FIG. 1 is a hand-held portable unit, it should be appreciated that a non-portable, stationary unit and a portable unit that is not hand-held are also included within the scope of the present invention. As will be described in more detail below, the biometric authentication device 10 is suitable for generating authentication information about a person on the basis of received biometric information.

In the non-limiting embodiment shown, the biometric authentication device 10 includes a housing 12 for enclosing electronic circuitry and a battery (not shown). It is the battery that supplies electrical power to the device 10. The housing 12 is preferably of an ergonomically designed shape that is suitable for being carried in the hand of a human operator. However, it should be appreciated that the housing 12 can be of any suitable shape and/or size without departing from the spirit of the invention. The biometric authentication device also includes a user interface 14 located on a front face of the housing 12. The user interface 14 is operative for enabling a user, and/or a person being authenticated, to enter required information and to view any information that is conveyed by the device 10.

In the non-limiting embodiment shown, the user interface 14 includes a first interface 18 for receiving live biometric information, a display screen 20, user operable inputs 22 and a second interface 16 for receiving stored biometric information. Each of these components will be described in more detail below. It should be appreciated that the configuration and layout of the components included in the user interface 14 shown in FIG. 1 have been presented for the purpose of illustration only and can vary from one implementation to the other without departing from the spirit of the invention.

The biometric authentication device 10 further includes a third interface 30, which in the embodiment shown is in the form of an RF transceiver. As will be described in more detail below, the third interface 30 is operative for enabling the biometric authentication device 10 to communicate with one or more external computing entities. Depending on the type of communication link established between the biometric authentication device 10 and an external entity, the third interface could also be in the form of a USB port, an infrared transceiver, a LAN or WLAN connection, a Bluetooth communications link, or a cellular communications link among others.

In the non-limiting embodiment shown in FIG. 1, the first interface 18 is a fingerprint scanner suitable for capturing a digital representation of a person's fingerprint. More specifically, in the embodiment depicted in FIG. 1, the first interface 18 includes a fingerprint scanner adapted for receiving thereon at least a portion of a person's finger to obtain fingerprint information. However, it should be appreciated that any suitable type of biometric information, such as iris information, retinal information, voice recognition information or face recognition information, could also be used by the biometric authentication device 10 for the purposes of the present invention. As such, depending on the type of biometric information that is used by the biometric authentication device 10, the first interface 18 could be a iris scanner, a retinal scanner, a microphone for obtaining a voiceprint of a person or a camera for obtaining a picture of a person, among other possibilities. In addition, it should be appreciated that the first interface 18 may be operative to obtain more than one type of biometric information. For example, the first interface 18 may be operative to obtain both fingerprint information and iris information.

The display screen 20 may be any type of suitable display screen known in the art, such as a CRT screen, an LCD screen or a plasma screen, for example. The display screen 20 is an optional component, and in alternative embodiments of the present invention, a display screen 20 is not included in the biometric authentication device 10. Instead, information can be conveyed to a user via a set of lights, such as for example using LEDs, or via an audio signal, among other possibilities.

The user operable inputs 22 enable a user, or a person being authenticated, to enter information into the biometric authentication device 10. In the embodiment shown, the user operable inputs 22 are in the form of four directional push-buttons 21a-21d. It should be appreciated that the user operable inputs 22 can be in any form suitable for enabling a user to enter information. For example, the user operable inputs 22 may be in the form of push-buttons, levers, dials, a keypad, a touch-sensitive screen, a pointing device or a voice recognition device.

The second interface 16 is operative for receiving electronically stored biometric information from contactless electronic chips. The chips may be contained in paper documentation, or in a smart card, for example. Shown in FIG. 1 is a smart card 26 containing an electronic chip 28 that contains stored biometric information associated to the owner of the smart card.

Contactless smart cards are known in the art, and generally include a microcontroller or equivalent intelligence, internal memory and a small antenna embedded within the plastic body of the card for communicating with a reader through a contactless radio frequency (RF) interface. The information contained in the smart card is stored on an electronic chip. When the smart card is placed within a magnetic or electromagnetic field of a smart card reader, the magnetic or electromagnetic field powers the card and causes the data stored in the chip to be exchanged with the reader. More specifically, when the card is brought into the electromagnetic field of the reader, the chip in the card is powered on, and a wireless communication protocol is initiated and established between the card and the reader for data transfer.

Electronic chips that are used in smart cards and/or other documentation can store information in a variety of different formats. The different formats may be different data storage formats or different encoding formats, for example.

In the embodiment shown in FIG. 1, the second interface 16 is an electronic chip reader 16 that is suitable for emitting an electromagnetic field, such that it is able to power on and exchange information with chips contained in smart cards and/or other documentation. Although the second interface 16 shown in FIG. 1 includes only one reader, it should be appreciated that any number of different readers could be included within the biometric authentication device 10 without departing from the spirit of the present invention. For example, multiple different readers that each emit a different frequency may be provided in order to be able to accommodate chips that are activated by different frequencies.

Given that the information received from the electronic chip can be in a variety of different formats, once information from the electronic chip has been received at the reader, the biometric authentication device 10 first determines the format associated with the chip, and then converts the information contained in that chip to a common reference format. In this manner, instead of having to provide different versions of an application software for processing the information received from the electronic chip, a single version of the application software can be used by the biometric authentication device for processing information in the common reference format.

Specific examples of the manner in which the information received from the electronic chip can be converted to the common reference format are described herein below.

Functional Block Diagram

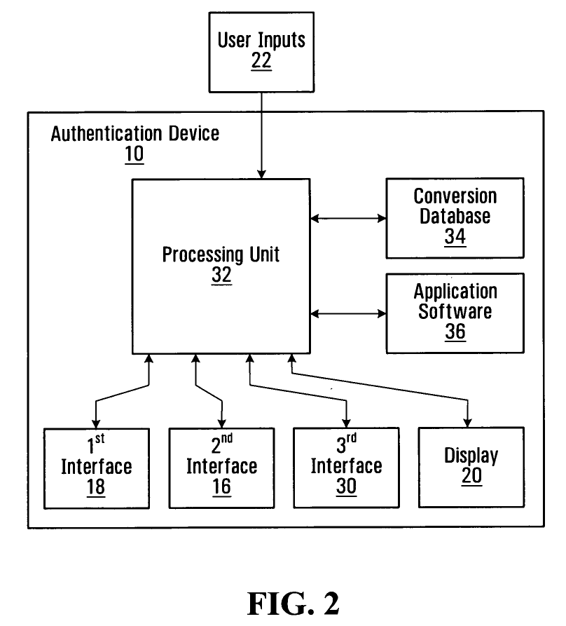

Shown in FIG. 2 is a functional block diagram of the biometric authentication device 10. In addition to the first interface 18, the second interface 16, the third interface 30 and the display 20, the biometric authentication device 10 further includes a processing unit 32, a conversion database 34 and application software 36. As will be described in more detail below, the processing unit 32 is operative for processing the information received from the first and second interfaces 18, 16, on the basis of the conversion database 34 and the application software 36, in order to generate authentication information.

The conversion database 34 includes a plurality of different entries, wherein each is associated to a respective format of information that could be detected from an electronic chip that the device 10 is adapted to read. As such, the entries of the conversion database are associated to respective formats and include format identifiers and conversion instructions for converting information in each of the respective formats into information in a common reference format. The processing unit 32 is operative for using the conversion instructions for converting information stored in the contactless chip into the common reference format.

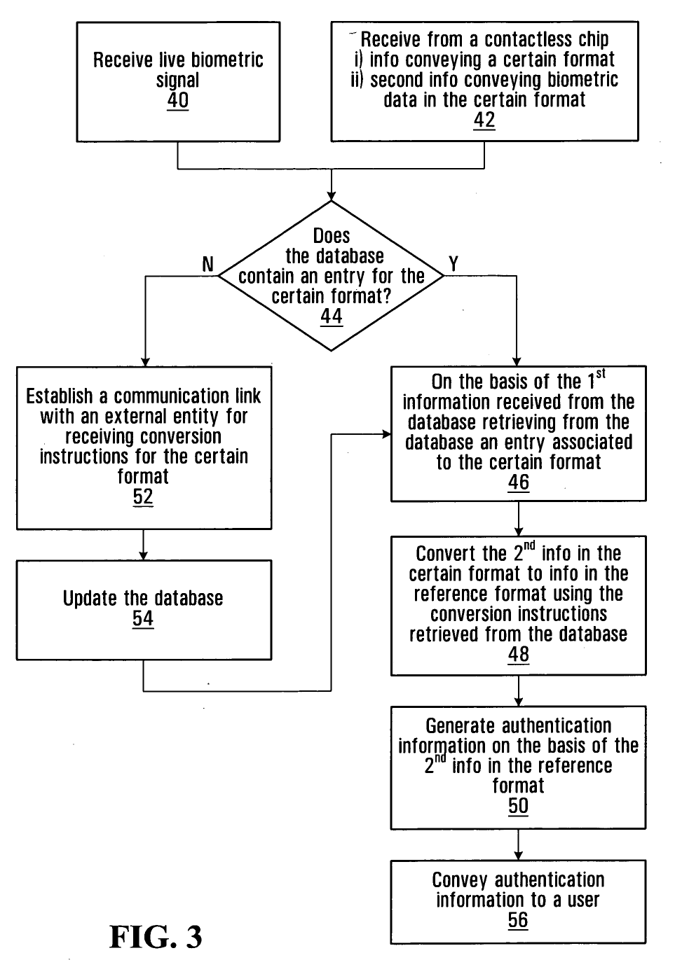

The manner in which the processing unit 32 uses the conversion database 34 and the application software 36 in order to generate the authentication information will now be described in more detail with respect to the flow diagram shown in FIG. 3.

Method of FIG. 3

At step 40 the processing unit 32 receives from the first interface 18 a live biometric signal. For the purposes of the present explanation, the live biometric signal will be a digital representation of a person's fingerprint. As such, when a person places his or her fingerprint on the first interface 18 (i.e. the fingerprint scanner) the fingerprint scanner captures a digital representation of the person's fingerprint, and transmits that signal to the processing unit 32 (shown in FIG. 2). Although this step is being described first, as will be described further on in the specification, this step is not necessarily the first step in the process.

At step 42, the processing unit 32 receives from an electronic chip 28 the following two pieces of information:
i) first information conveying a certain format associated with the contactless chip; and
ii) second information for conveying stored biometric information, and optionally other nominative information, in the certain format. The nominative information may include for example, without being limited to, a person's name, birthday, address, citizenship, passport number, driver's license and any other information that may be of interest depending on the specific application.

The certain format associated with the contactless chip may be any one of a variety of different possible formats. There are many different formats known in the art for storing information in a contactless chip (ICAO passports LDS, GSC-IS,CATSA, CAC card), as well as different protocols (ISO 14443 Type A/B/C/D, ISO 15693) used for communications. For the purpose of the present application, the expression “format” when used in association with a contactless chip is used to refer to either one of a storage format or a communication protocol used by the contactless chip. The certain format may be any one of these formats, or even a newly developed format that is not commonly known in the art.

The first information for conveying the certain format will be included in the chip in a format that can be understood by different readers so that regardless of the type of reader (or readers) that are used by the biometric authentication device 10, the biometric authentication device 10 will be able to detect the first information that conveys the certain format being used by the electronic chip. For example, this first information may be in the form of a code, index or reference number that is stored in an agreed upon location on the chip. Typically a contactless chip when powered “ON” transmits an answer to reset (ATS) i.e. a stream of bytes that also enable to specify which type of card is being presented to the reader.

Once the processing unit 32 has received the first and second information from the second interface 16, the method proceeds to step 44, wherein the processing unit 32 determines, at least in part on the basis of the first information that conveys the certain format, whether the conversion database 34 includes an entry for that certain format.

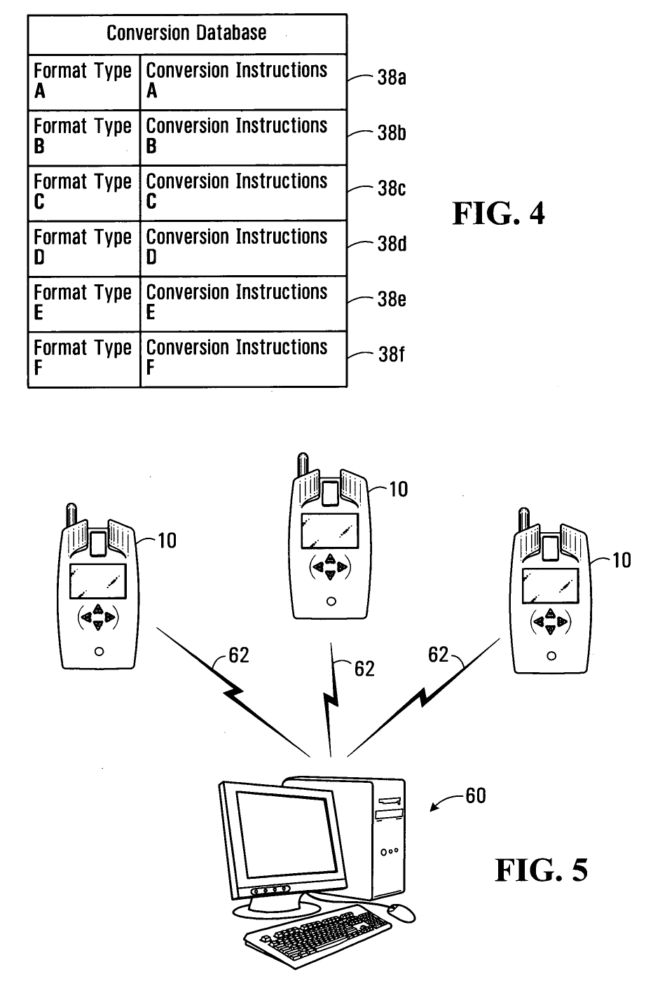

Shown in FIG. 4 is a non-limiting example of a conversion database 34 in accordance with an example of implementation of the present invention. As shown, the conversion database 34 includes a plurality of entries 38a-38f, each of which corresponds to a respective format in a set of possible formats. Each of the respective formats is a possible format that could be used by a contactless chip for storing information. Each entry further includes conversion instructions that are suitable for converting information in that respective format into information in a common reference format. Methods for converting information from a given format to another format are known in the art of computing and as such will not be described in greater detail here.

Referring back to FIG. 3, in the case where the processing unit 32 determines at step 44 that the conversion database 34 includes an entry for the certain format associated with the contactless chip, then the method proceeds to step 46. However, if the processing unit 32 determines that the conversion database 34 does not include an entry for the certain format, then the method proceeds to step 52. Steps 52 and 54 of the method will be described in more detail below.

Assuming that the conversion database 34 does include an entry for the certain format, at step 46 the processing unit 32 retrieves from the entry in the conversion database 34, the conversion instructions for that certain format. At step 48, the processing unit 32 processes the second information that conveys the stored biometric information that was received from the electronic chip, on the basis of the conversion instructions. In this manner, the stored biometric information is converted from the certain format into a common reference format.

At step 50, once the second information conveying the stored biometric information has been converted into the reference format, the processing unit 32 then makes use of the application software to process this second information, so as to generate authentication information. In accordance with a specific example of implementation, the processing unit 32 processes both the live biometric signal received from the first interface 16 and the stored biometric information received from the second interface on the basis of the application software in order to generate the authentication information.

Although step 40, which involves receiving the live biometric signal is shown as occurring roughly at the same time as step 42, it may not be necessary to receive the live biometric signal until after the processing unit 32 has converted the stored biometric information from the certain format into the common reference format. As such, step 40 may not occur until after step 48. In such a situation, the biometric authentication device 10 may use the display 20 to prompt a person to put his or her fingerprint on the fingerprint scanner 18, after the processing unit 32 has completed step 48.

In addition, although step 42 has been shown as receiving concurrently the information conveying the certain format and information conveying biometric data in the certain format, it may not be necessary to receive the live biometric signal until after the processing unit 32 has located in the database 34 (shown in FIG. 2) the entry corresponding to the certain format or until the database 34 has been updated to include such an entry. As such, receiving the information conveying biometric data in the certain format from the electronic chip may occur after steps 44 (or 54 in the case where no entry corresponding to the certain format was detected in the database 34). In such a situation, the biometric authentication device 10 may use the display 20 to prompt a person to keep the contactless card in proximity to the reader.

The application software 36 may include any type of program instructions suitable for causing the processing unit 36 to generate authentication information. In addition, it should be appreciated that the authentication information may take on many different forms. For example, the authentication information may be indicative that the live biometric signal and the stored biometric information from the contactless chip match. The authentication information may also indicate a level of confidence for the match. For example, indicating that they are a match at 95%. Any suitable algorithm for deriving authentication information on the basis of biometric information may be used without detracting from the spirit of the invention. The specific process applied by the application software is not critical to the present application and as such will not be described further here.

As a variant, the authentication information may indicate that the person who presented the contactless chip is a non-authorised person, or has some sort of authorised status or instead that the person is on some alert list, such as a restricted travel list. In yet a further alternative, the authentication information may be indicative of the person's name, birth date and picture. In such circumstances, the biometric authentication device 10 may include an additional database storing information indicative of a list of authorised people, unauthorised people, and/or information such as the name and birth date associated with authorised people. Alternatively, such information may be stored on an external data storage entity (not show in the figure) and the biometric authentication device 10 is adapted for accessing this external data storage entity for extracting certain authentication information therefrom. The external data storage entity may be a memory device in communication with the biometric authentication device 10 through a communication link which can be a wire link or a wireless link and may be a standalone external data storage entity or may be part of a computing apparatus distinct from the biometric authentication device 10. Upon receipt of biometric information from the electronic chip, the processing unit 32 (shown in FIG. 2) will determine whether the received biometric information matches information included in its database of authorised people. In light of these examples, it should be appreciated that any suitable type of information for authenticating or screening a person may be generated by the biometric authentication device 10.

Once the authentication information has been derived, the method proceeds to step 56, wherein the authentication information generated by the processing unit 32 is conveyed to a user. This may be done in a variety of different ways. For example, the authentication information may be conveyed via text or pictograms presented on the display screen 20. Alternatively, the authentication information may be conveyed via flashing lights, a beeping sound, or synthesised speech, among other possibilities. For example, in the case where the authentication information generated by the biometric authentication device 10 is indicative that the live biometric signal matches the stored biometric information, this information may be presented to a user via a flashing light. As such, once a user sees that a light has started to flash, the user will know that the person being screened has been authenticated. In an alternative example, in the case where the authentication information generated by the biometric authentication device 10 is indicative that the live biometric signal matches the stored biometric information, this information may be presented to a user via a green light. Conversely, where the authentication information generated by the biometric authentication device 10 is indicative that the live biometric signal does not match, this information may be presented to a user via a red light.

Referring back to step 44 of the method, in the case where the processing unit 32 determines that the conversion database 34 does not include an entry for the certain format, then the processing unit 32 proceeds to step 52. At step 52, the processing unit causes a communication link to be established with an external entity, such that the processing unit 32 can receive from the external entity conversion instructions for converting the certain format into the reference format. As will be described in more detail below, for the purposes of the present application, the term “external computing entity” refers to any suitable computing entity distinct from said biometric authentication device 10 that contains a master conversion database and that can transfer information from this master conversion database to the biometric authentication device 10 over an established communication link.

Once a communication link has been established with the external computing entity, the processing unit 32 issues a signal for prompting the external computing entity to transfer conversion information associated to the certain format from its master conversion database to the biometric authentication device 10.

The processing unit 32 then proceeds to step 54, wherein the processing unit 32 updates the conversion database 34 on the basis of the information received from the external computing entity. In this manner, the conversion database 34 is updated in order to include an entry for the certain format. As such, if this format is received again from another contactless chip, the biometric authentication device 10 will be able to identify and process the information contained in this format.

Once the conversion database 34 has been updated, the processing unit 32 proceeds to steps 46, 48, 50 and 52, as described above, in order to convert the stored biometric data into the reference format and generate authentication information.

External Computing Entity

Shown in FIG. 5 is an external computing entity 60 that is suitable for establishing communication links with a plurality of portable biometric authentication devices 10 over respective communication links 62. As mentioned above, the external computing entity 60 can be any form of computing entity that contains a master conversion database, and that can transfer information to one or more biometric authentication devices 10 over a communication link.

In the embodiment shown in FIG. 5, the communication links 62 between the biometric authentication devices 10 and the external entity 60 are wireless RF links. It should, however, be appreciated that each biometric authentication device 10 may communicate with the external entity 60 via other types of communication links, such as wireless IR links, or via wireline links, for example. The biometric authentication device 10 may also be connected to an external computing entity over a network arrangement, such as over an intranet, or over the Internet.

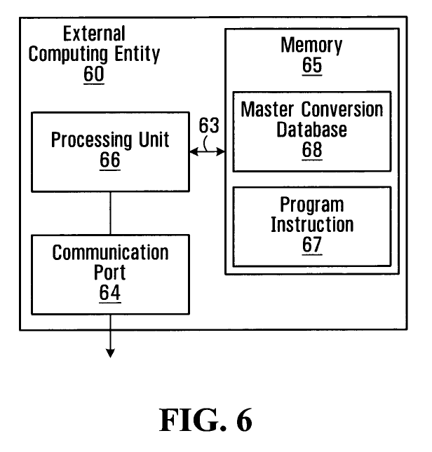

Shown in FIG. 6 is a functional block diagram of an external computing entity 60 in accordance with a specific embodiment of the present invention. As shown, the external entity 60 includes a communication port 64, a processing unit 66 and a memory 65 for storing a master conversion database 68 and program instructions 67.

The communication port 64 is operative for establishing a communication link with a biometric authentication device 10 via the third interface 30 of the biometric authentication device 10 (shown in FIG. 2). Depending on the type of communication link 64 that can be established between the external computing entity 60 and the biometric authentication devices 10, the communication port 64 can be a USB port, an RF transceiver, an infrared (IR) transceiver, or any other suitable communication port known in the art. In addition, the communication port 64 can be comprised of separate input and output ports, or alternatively, the communication port 64 may be a combined input/output port.

The master conversion database 68 contained within the external computing entity 60 includes a set of entries, each being associated to a respective format. The set of entries in the master conversion database 68 is a more complete set of entries than the conversion database 34 (shown in FIG. 2) contained at the biometric authentication device 10. More specifically, each entry in the master conversion database 68 is associated to a respective format in a set of possible formats and includes conversion instructions for converting information in the respective format into information in a common reference format. The master conversion database 68 may also include updates to existing formats and/or newly introduced formats. By having the master conversion database 68 contain a more complete list of entries than the conversion database 34 (shown in FIG. 2), the amount of memory required at the biometric authentication device 10 is reduced.

In addition, since the biometric authentication device 10 is adapted to communicate with the external computing entity 60 when a certain format is detected as being absent from its conversion database 34 (shown in FIG. 2), the biometric authentication device 10 need not be brought in for servicing to update the conversion database 34 each time a new format is introduced into the system. Rather, when a new format is introduced, only the master conversion database 68 needs to be updated. The database in each biometric authentication device 10 can be updated when the new format is detected on a certain chip. Advantageously, this allows a reduction in the amount of idle time spent by the biometric authentication device 10 since they do not need to be taken out of service to be updated.

In an alternative example of implementation, the conversion database 34 (shown in FIG. 2) of the biometric authentication device 10 may be used to store entries associated to the most commonly used formats. For formats that are less common, entries may be stored in the master conversion database 68 and made available to the biometric authentication device 10 upon request. As such, the biometric authentication device 10 needs only to communicate with the external communication entity 60 upon detection of an absence of a certain format in its conversion database 34 (shown in FIG. 2), in order to obtain the appropriate format entry from the external entity 60.

At step 52 of the method described above with respect to FIG. 3, when the biometric authentication device 10 establishes a communication link with the external entity 60 for retrieving conversion instructions, the processing unit 66 of the external entity 60 receives a signal from the biometric authentication device 10, requesting from the external entity 60 conversion instructions for converting information in a certain format into information in a common reference format. Upon receipt of the signal, the processing unit 66 locates in the master conversion database 68 an entry corresponding to the certain format. The external entity 60 then releases a signal conveying these conversion instructions at the communication port 64 for transmission to the biometric authentication device 10.

Those skilled in the art should appreciate that in some embodiments of the invention, all or part of the functionality previously described herein with respect to the external computing entity 60 may be implemented as pre-programmed hardware or firmware elements (e.g., application specific integrated circuits (ASICs), electrically erasable programmable read-only memories (EEPROMs), etc.), or other related components.

In other embodiments of the invention, all or part of the functionality previously described herein with respect to external computing entity 60 may be implemented as software consisting of a series of instructions for execution by a computing unit. The series of instructions could be stored on a medium which is fixed, tangible and readable directly by the computing unit, (e.g., removable diskette, CD-ROM, ROM, PROM, EPROM or fixed disk), or the instructions could be stored remotely but transmittable to the computing unit via a modem or other interface device (e.g., a communications adapter) connected to a network over a transmission medium. The transmission medium may be either a tangible medium (e.g., optical or analog communications lines) or a medium implemented using wireless techniques (e.g., microwave, infrared or other transmission schemes).

The external computing entity 60 may be configured as a computing entity of the type depicted in FIG. 6, including a processing unit 66 and a memory 65 connected by a communication bus 63. The memory 65 includes data, such as the master conversion database 68, and the program instructions 67. The processing unit 66 is adapted to process the data 68 and the program instructions 67 in order to implement the process described above.

It will be appreciated that the external computing entity 60 for providing conversion instructions may also be of a distributed nature where the request for conversion instructions is collected at one location and is then transmitted over a network to a server unit storing the master conversion database 68 and the program instructions 67. The server unit may then transmit a signal for conveying the conversion instructions over the network.

A plurality of biometric authentication devices 10 may be connected to the server unit through a network. The communication links between the plurality of biometric authentication devices 10 and the server unit can be metallic conductors, optical fibers or wireless, without departing from the spirit of the invention. The network may be any suitable network including but not limited to a global public network such as the Intranet, a private network and a wireless network. The server may be adapted to process signals requesting conversion instructions, and issue signals for releasing conversion instructions concurrently using suitable methods known in the computer related arts.

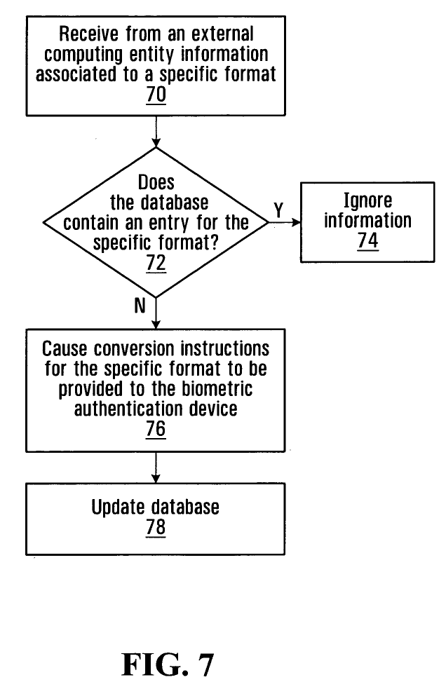

Method of FIG. 7

The method described above with respect to steps 52 and 54 in FIG. 3 is a method for the biometric authentication device 10 to update its conversion database 34 “on-the-fly”. In other words, the update is only performed if and when the biometric authentication device 10 needs the updated information. It should be appreciated that in a further non-limiting embodiment of the present invention, instead of or in addition to updating information in the conversion database 34 “on-the-fly”, the conversion database 34 may be updated as new formats or new versions of an old format become available, and not just when the updated information is needed. Such a method will be described in more detail below with respect to FIG. 7.

At step 70, the biometric authentication device 10 receives via the third interface 30 (shown in FIG. 2) information associated to a specific format from an external computing entity 60. Such information associated to the specific format is generated by the processing unit 66 of the external entity 60 (shown in FIG. 6) and is released from the communication port 64 towards one or more biometric authentication devices 10.

At step 72, the processing unit 32 of the biometric authentication device 10 determines whether an entry associated to the specific format is included within its conversion database 34. This may be done by comparing the specific format received from the external entity 60 with each format contained in the conversion database 34. It can also verify whether there is a change in the version of a format already stored in the conversion database 34.

In the case where the processing unit 32 determines that the conversion database includes an entry associated with the specific format, then the processing unit 32 proceeds to step 74, wherein it essentially ignores the information received from the external entity 60, and does nothing. Alternatively, in the case where the processing unit 32 determines that the conversion database does not include an entry associated with the specific format or detects that there has been a change in the version of a format stored in the conversion database, then the processing unit 32 proceeds to step 76. At step 76, the processing unit 32 causes conversion instructions for the specific format to be provided to the biometric authentication device 10.

The step of causing conversion instructions to be provided to the biometric authentication device 10 may be done in a variety of ways.

In accordance with a first non-limiting example, the processing unit 32 may cause a message to be displayed on the display screen 20, prompting the user to insert a CD, or connect to a website, for downloading the conversion instructions associated to the specific format.

In accordance with a second non-limiting example, the processing unit 32 transmits a signal to the external computing entity 60, for requesting that the external entity 60 transfer the conversion instructions from the master conversion database 68 to the biometric authentication device 10 over a communication link 62. As described above, such a communication link 62 may be an RF, IR link or a wireline communication link. Suitable hand-shaking protocols may be used for establishing the communication link for allowing the biometric authentication device 10 to receive the requested conversion instructions.

In a non-limiting implementation, the processing unit 66 of the external computing entity 60 is operative for receiving a return signal from the biometric authentication device 10 requesting that the external computing entity 60 transfer conversion instructions and for retrieving the conversion instructions associated to the specific format from its master conversion database 68. The processing unit 66 of the external entity 60 then releases at the communication port 64 a signal conveying the conversion instructions for converting information in the specific format into information in the reference format.

Finally, once the conversion instructions for the specific format have been received by the biometric authentication device 10, the processing unit 32 of the biometric authentication device 10 proceeds to step 78 where it updates the conversion database 34 by adding an entry for the specific format, including conversion instructions for converting information in the specific format into information in the common reference format.

In a variant, not shown in the figures, the biometric authentication device 10 is adapted for periodically establishing a communication link with external computing entity 60 for prompting the latter to transmit conversion instructions associated to new formats or updated formats. In a non-limiting implementation of this variant, the external computing entity 60 may maintain information conveying the time of the last update associated with the specific biometric authentication device 10. Upon receipt of a signal from the specific biometric authentication device 10, the external computing entity 60 is adapted for transmitting to the specific biometric authentication device 10 conversion instructions associated to new formats or updated formats which were added to the master conversion database subsequent to the time of the last update. The specific biometric authentication device 10, upon receipt of the conversion instructions associated to new formats or updated formats, updates its conversion database. The external computing entity 60 is also adapted for updating the time of the last update associated to the specific biometric authentication device 10.

The frequency at which the biometric authentication device 10 establishes a communication link with external computing entity 60 may vary from one implementation to the other and is not critical to the invention. In addition, the communication link between the biometric authentication device 10 and the external computing entity 60 may be established at regular or irregular time intervals. Alternatively, the communication link between the biometric authentication device 10 and the external computing entity 60 may be established when the biometric authentication device 10 remains idle for a certain period of time. Advantageously, this alternative allows taking advantage of the biometric authentication device's idle time to keep the conversion database up to date.

Specific Implementation

The biometric authentication device 10 described above may be used in a variety of different circumstances and contexts. In a specific, non-limiting example of use, the biometric authentication device 10 can be used at border crossings for authenticating a person on the basis of their identification documentation (such as a passport) that includes stored biometric information. For the purposes of this example, the stored biometric information will be fingerprint information.

In a typical interaction, a border-crossing official will be responsible for holding and operating the biometric authentication device 10. As a traveller approaches the border, the border-crossing official will ask the traveller to present his/her identification documentation. The border-crossing official will then pass the identification documentation in proximity to the second interface 16, namely the contactless chip reader, such that the contactless chip reader will power the electronic chip and receive information about the certain format of the chip, and the stored fingerprint information in that certain format. At the same time, the border-crossing official will ask the traveller to put his or her finger on the first interface 16, which includes a fingerprint scanner.

The biometric authentication device 10 will then process the information about the certain format of the chip on the basis of the conversion database 34. Assuming that the conversion database 34 contains an entry associated with the certain format, the biometric authentication device 10 uses the conversion instructions contained in the conversion database for converting the stored fingerprint information in the certain format into information in the reference format.

Once the stored fingerprint information has been converted into the reference format, the biometric authentication device 10 provides the information in the reference format and the live fingerprint signal obtained at the fingerprint scanner 16 to the application software. The application software processes that information to generate authentication information. In this specific example, the application software will determine whether the live fingerprint signal matches the fingerprint information stored on the electronic chip. As such, the authentication information will be indicative of whether the live fingerprint signal and the stored fingerprint information match. In the case where they do match, the biometric authentication device 10 conveys this information to the border-crossing official via the display 20. For example, the display screen 20 may provide a message such as “AUTHORIZED TRAVELLER”, may issue an audio signal indicative that there is a match or may cause a visual indicator (such as an LED) to be actuated to indicate that the screening resulted in a match. Optionally, a level of confidence for the match may also be provided via the display 20. In the case where the live fingerprint signal and the stored fingerprint information do not match, the display screen 20 may provide a message such as “INVALID DOCUMENTATION”, may issue an audio signal indicative that there is not a match or may cause a visual indicator (such as an LED) to be actuated to indicate that the screening did not result in a match. Based on the authentication information generated by the biometric device, the border-crossing official can then decide whether or not to allow the traveller to cross the border.

Although the present invention has been described in considerable detail with reference to certain preferred embodiments thereof, variations and refinements are possible without departing from the spirit of the invention. Therefore, the scope of the invention should be limited only by the appended claims and their equivalents.

1. In a biometric authentication device including a first interface for receiving a live biometric signal associated to a person, a second interface for receiving information from a contactless chip and a conversion database having a plurality of entries, the entries being associated to respective formats and including conversion instructions for converting information from each of the respective format into information into a common reference format, a method for providing authentication information associated to the person, said method comprising:
a) receiving at said second interface information conveying a certain format associated with the contactless chip, the certain format being selected from a plurality of possible formats, the set of possible formats including at least one format absent from the conversion database;
b) attempting to locate an entry in the conversion database corresponding to the certain format;
c) in the absence of an entry in the conversion database associated to the certain format:
i. establishing a communication link with an external entity for issuing a request to receive conversion instructions for converting information in the certain format to information in the common reference format;
ii. receiving a signal conveying conversion instructions for converting information in the certain format to information in the common reference format;
iii. updating the conversion database to include an entry associated to the certain format at least in part on the basis of the signal received in ii.

2. A method as defined in claim 1, wherein said information received at said second interface is first information, said method comprising:
a) receiving second information conveying biometric data, said second information being in the certain format;
b) when an entry corresponding to the certain format has been located in the conversion database:
i. converting said second information to the common reference format at least in part on the basis of the entry in the conversion database corresponding to the certain format;
ii. deriving authentication information associated to the person at least in part on the basis of the second information in the common reference format.

3. A method as defined in claim 2, wherein the second information conveys nominative information in addition to biometric data.

4. A method as defined in claim 3, wherein said nominative information includes at least one item of information selected from the set consisting of a name, birthday, address, citizenship, passport number and driver's license number.

5. A method as defined in claim 1, wherein said communication link is a wireless communication link.

6. A method as defined in claim 5, wherein said wireless communication link is an RF link.

7. A method as defined in claim 5, wherein said wireless communication link is an IR link.

8. A method as defined in claim 1, further comprising receiving at the first interface a live biometric signal associated to the person.

9. A method as defined in claim 8, further comprising deriving authentication information associated to the person at least in part on the basis of the second information in the common reference format and the live biometric signal associated to the person.

10. A method as defined in claim 9, further comprising deriving authentication information associated to the person by comparing the second information in the common reference format with the live biometric signal associated to the person.

11. A method as defined in claim 10, wherein the live biometric signal conveys a fingerprint of the person, and wherein the second information received at the second interface is indicative of stored data associated to the fingerprint of the person.

12. A method as defined in claim 8, wherein the live biometric signal conveys one of retinal information, iris information, facial recognition information and voice recognition information, and wherein the second information received at the second interface is indicative of a corresponding one of stored retinal information, stored iris information, stored facial recognition information and voice recognition information.

13. A method as defined in claim 2, wherein said authentication information is indicative of one of a positive identification of the person and a negative identification of the person.

14. A biometric authentication device, comprising;
a) a first interface for receiving a live biometric signal associated to a person;
b) a conversion database having a plurality of entries, the entries being associated to respective formats and including conversion instructions for converting information from each of the respective format into information into a common reference format;
c) a second interface for receiving information from a contactless chip, said information conveying a certain format associated with the contactless chip, the certain format being selected from a plurality of possible formats, the set of possible formats including at least one format absent from the conversion database;
d) a processing unit in communication with said first interface, said second interface and said conversion database, said processing unit being operative for deriving authentication information associated to the person, in the absence of an entry in said conversion database associated to the certain format, said processing unit being operative for:
i. establishing a communication link with an external entity for issuing a request to receive conversion instructions for converting information in the certain format to information in the common reference format;
ii. receiving a signal conveying conversion instructions for converting information in the certain format to information in the common reference format;
iii. updating the conversion database to include an entry associated to the certain format at least in part on the basis of the signal received in ii;
e) an output for releasing a signal conveying the authentication information.

15. A biometric authentication device as defined in claim 14, wherein said information received at said second interface is first information, said second interface being adapted for receiving second information conveying biometric data, said second information being in the certain format, said processing unit being operative for:
a) attempting to locate an entry in the conversion database corresponding to the certain format;
b) when an entry corresponding to the certain format has been located in the conversion database:
i. converting said second information to the common reference format at least in part on the basis of the entry in the conversion database corresponding to the certain format;
ii. deriving authentication information associated to the person at least in part on the basis of the second information in the common reference format.

16. A biometric authentication device as defined in claim 15, wherein the second information conveys nominative information in addition to biometric data.

17. A biometric authentication device as defined in claim 16, wherein said nominative information includes at least one item of information selected from the set consisting of a name, birthday, address, citizenship, passport number and driver's license number.

18. A biometric authentication device as defined in claim 14, wherein said communication link is a wireless communication link.

19. A biometric authentication device as defined in claim 18, wherein said wireless communication link is an RF link.

20. A biometric authentication device as defined in claim 18, wherein said wireless communication link is an IR link.

21. A biometric authentication device as defined in claim 15, further comprising deriving authentication information associated to the person at least in part on the basis of the second information in the common reference format and the live biometric signal associated to the person.

22. A biometric authentication device as defined in claim 21, further comprising deriving authentication information associated to the person by comparing the second information in the common reference format with the live biometric signal associated to the person.

23. A biometric authentication device as defined in claim 22, wherein the live biometric signal received at the first interface conveys a fingerprint of the person, and wherein the second information received at the second interface is indicative of stored data associated to the fingerprint of the person.

24. A biometric authentication device as defined in claim 14, wherein the live biometric signal received at the first interface conveys one of retinal information, iris information, voice recognition information and face recognition information, and wherein the second information received at the second interface is indicative of a corresponding one of stored retinal information, iris information, voiceprint information and face recognition information.

25. A biometric authentication device as defined in claim 15, wherein said authentication information is indicative of one of a positive identification of the person and a negative identification of the person.

26. A biometric authentication device as defined in claim 14, wherein said biometric authentication device is a portable unit.

27. A biometric authentication device as defined in claim 14, wherein said first interface includes a fingerprint scanner adapted for receiving thereon at least a portion of a person finger to obtain fingerprint information.

28. A computer readable storage medium including a program element suitable for execution by a computing apparatus for providing authentication information associated to a person, said computing apparatus comprising:
a) a memory unit for storing a conversion database including a plurality of entries, the entries being associated to respective formats and including conversion instructions for converting information in each of the respective formats into information in a common reference format;
b) a processor in communication with said memory unit, said program element when executing on said processor being operative for:
i. receiving information conveying a certain format associated with the contactless chip, the certain format being selected from a plurality of possible formats, the set of possible formats including at least one format absent from the conversion database;
ii. attempting to locate an entry in the conversion database corresponding to the certain format;
iii. in the absence of an entry in the conversion database associated to the certain format:
(a) establishing a communication link with an external entity for issuing a request to receive conversion instructions for converting information in the certain format to information in the common reference format;
(b) receiving a signal conveying conversion instructions for converting information in the certain format to information in the common reference format;
(c) updating the conversion database to include an entry associated to the certain format at least in part on the basis of the signal received.

29. A computer readable medium as defined in claim 28, wherein said information received at said second interface is first information, said program element when executing on said processor being operative for:
a) receiving second information conveying biometric data, said second information being in the certain format;
b) when an entry corresponding to the certain format has been located in the conversion database:
i. converting said second information to the common reference format at least in part on the basis of the entry in the conversion database corresponding to the certain format;
ii. deriving authentication information associated to the person at least in part on the basis of the second information in the common reference format.

30. A computer readable medium as defined in claim 29, wherein the second information conveys nominative information in addition to biometric data.

31. A computer readable medium as defined in claim 30, wherein said nominative information includes at least one item of information selected from the set consisting of a name, birthday, address, citizenship, passport number and driver's license number.

32. A computer readable medium as defined in claim 28, wherein said communication link is a wireless communication link.

33. A computer readable medium as defined in claim 32, wherein said wireless communication link is an RF link.

34. A computer readable medium as defined in claim 32, wherein said wireless communication link is an IR link.

35. A computer readable medium as defined in claim 28, wherein said program element when executing on said processor is operative for receiving a live biometric signal associated to the person.

36. A computer readable medium as defined in claim 35, wherein said program element when executing on said processor is operative for deriving authentication information associated to the person at least in part on the basis of the second information in the common reference format and the live biometric signal associated to the person.

37. A computer readable medium as defined in claim 36, wherein said program element when executing on said processor is operative for deriving authentication information associated to the person by comparing the second information in the common reference format with the live biometric signal associated to the person.

38. A computer readable medium as defined in claim 37, wherein the live biometric signal conveys a fingerprint of the person, and wherein the second information received at the second interface is indicative of stored data associated to the fingerprint of the person.

39. A computer readable medium as defined in claim 35, wherein the live biometric signal conveys one of retinal information, iris information, voice recognition information and face recognition information, and wherein the second information received at the second interface is indicative of a corresponding one of stored retinal information, iris information, voiceprint information and face recognition information.

40. A computer readable medium as defined in claim 39, wherein said authentication information is indicative of one of a positive identification of the person and a negative identification of the person.

41. A biometric authentication device, comprising;
a) means for receiving a live biometric signal associated to a person;
b) conversion database means having a plurality of entries, the entries being associated to respective formats and including conversion instructions for converting information from each of the respective format into information into a common reference format;
c) means for receiving information from a contactless chip, said information conveying a certain format associated with the contactless chip, the certain format being selected from a plurality of possible formats, the set of possible formats including at least one format absent from the conversion database;
d) means for deriving authentication information associated to the person, in the absence of an entry in said conversion database means associated to the certain format, said means for deriving authentication information being operative for:
i. establishing a communication link with an external entity for issuing a request to receive conversion instructions for converting information in the certain format to information in the common reference format;
ii. receiving a signal conveying conversion instructions for converting information in the certain format to information in the common reference format;
iii. updating the conversion database means to include an entry associated to the certain format at least in part on the basis of the signal received in ii;
e) means for releasing a signal conveying the authentication information.

42. A computing entity suitable for communicating with one or more remote biometric authentication devices, said computing entity comprising:
a) a communication port suitable for exchanging signals with one or more biometric authentication devices;
b) a master conversion database including a plurality of entries, the entries in the master conversion database being associated to respective formats and including conversion instructions for converting information in each of the respective formats into information in a common reference format;
c) a processing unit in communication with said master conversion database and with said communication port, said processing unit being operative for:
i. receiving a signal originating from a certain biometric authentication device and conveying a request for conversion instructions for converting information in a certain format to information in the common reference format;
ii. locating in the master conversion database an entry corresponding to the certain format;
d) causing a signal to be released at said communication port for transmission to the certain biometric authentication device, the signal caused to be released conveying conversion instructions for converting information in the certain into information in the common reference format.

43. A computing entity as defined in claim 42, wherein said computing entity includes a server system.

44. A computing entity as defined in claim 43, wherein said communication port includes an RF transceiver.

45. A computing entity as defined in claim 43, wherein said communication port includes an IR transceiver.

46. In a biometric authentication device including a first interface for receiving a live biometric signal associated to a person, a second interface for receiving information from a contactless chip, a third interface for communicating with an external computing entity and a conversion database having a plurality of entries, the entries being associated to respective formats and including conversion instructions for converting information from each of the respective format into information into a common reference format, a method for updating the conversion database, said method comprising:
a) receiving at said third interface information associated to a certain format from the external computing entity;
b) attempting to locate an entry in the conversion database corresponding to the certain format;
c) in the absence of an entry in the conversion database associated to the certain format:
i. establishing a communication link with the external computing entity for receiving conversion instructions for converting information from the certain format to the common reference format;
ii. updating the conversion database to include an entry associated to the certain format.

47. A method as defined in claim 46, wherein said communication link is a wireless communication link.

48. A method as defined in claim 47, wherein said wireless communication link is an RF link.

49. A method as defined in claim 47, wherein said wireless communication link is an IR link.

50. A biometric authentication device, comprising;
a) a first interface for receiving a live biometric signal associated to a person;
b) a second interface for receiving information from a contactless chip;
c) a third interface for communicating with an external computing entity;
d) a conversion database having a plurality of entries, the entries being associated to respective formats and including conversion instructions for converting information from each of the respective format into information into a common reference format; and
e) a processing unit in communication with said first interface, said second interface, said third interface and said conversion database said processing unit being operative for:
i. receiving information associated to a certain format from the external computing entity;
ii. attempting to locate an entry in the conversion database corresponding to the certain format;
iii. in the absence of an entry in the conversion database associated to the certain format:
(a) establishing a communication link with the external computing entity for receiving conversion instructions for converting information from the certain format to the common reference format;
(b) updating the conversion database to include an entry associated to the certain format.

51. A biometric authentication device as defined in claim 50, wherein said communication link is established over a wireless communication link.

52. A biometric authentication device as defined in claim 51, wherein said wireless communication link is an RF link.

53. A biometric authentication device as defined in claim 51, wherein said wireless communication link is an IR link.

54. A computer readable storage medium including a program element suitable for execution by a computing apparatus for providing authentication information associated to a person, said computing apparatus comprising:
a) a memory unit for storing a conversion database including a plurality of entries, the entries being associated to respective formats and including conversion instructions for converting information in each of the respective formats into information in a common reference format;
b) a processor in communication with said memory unit, said program element when executing on said processor being operative for:
i. receiving information associated to a certain format from an external computing entity;
ii. attempting to locate an entry in the conversion database corresponding to the certain format;
iii. in the absence of an entry in the conversion database associated to the certain format:
(a) establishing a communication link with the external computing entity for receiving conversion instructions for converting information from the certain format to the common reference format;
(b) updating the conversion database to include an entry associated to the certain format.

55. A computer readable storage medium as defined in claim 54, wherein said communication link is a wireless communication link.

56. A computer readable storage medium as defined in claim 55, wherein said wireless communication link is an RF link.

57. A computer readable storage medium as defined in claim 55, wherein said wireless communication link is an IR link.

58. A computing entity suitable for communicating with one or more remote biometric authentication devices, said computing entity comprising:
a) a communication port suitable for exchanging signals with one or more biometric authentication devices;
b) a master conversion database including a plurality of entries, the entries in the master conversion database being associated to respective formats in a set of possible formats and including conversion instructions for converting information in each of the respective formats into information in a common reference format;
c) a processing unit in communication with said master conversion database and with said communication port, said processing unit being operative for:
i. releasing a first signal at said communication port for transmission to one or more biometric authentication devices, the first signal conveying a certain format from the set of possible format for which conversion instructions for converting information from the certain format into information in the common reference format are available in the master conversion database;
ii. in response to an incoming signal originating from a certain biometric authentication device and conveying a request for conversion instructions for converting information in the certain format to information in the common reference format, releasing at said communication port a second signal conveying conversion instructions for converting information in the certain into information in the common reference format for transmission to the certain biometric authentication device.

59. A computing entity as defined in claim 58, wherein said computing entity includes a server system.

60. A computing entity as defined in claim 59, wherein said communication port includes an RF transceiver.

61. A computing entity as defined in claim 59, wherein said communication port includes an IR transceiver.

62. A biometric authentication device, comprising;
a) means for receiving a live biometric signal associated to a person;
b) means for receiving information from a contactless chip;
c) means for communicating with an external computing entity;
d) a conversion database having a plurality of entries, the entries being associated to respective formats and including conversion instructions for converting information from each of the respective format into information into a common reference format; and
e) processing means operative for:
i. receiving information associated to a certain format from the external computing entity;
ii. attempting to locate an entry in the conversion database corresponding to the certain format;
iii. in the absence of an entry in the conversion database associated to the certain format:
(a) establishing a communication link with the external computing entity for receiving conversion instructions for converting information from the certain format to the common reference format;
(b) updating the conversion database to include an entry associated to the certain format.
